(19) United States
(12) Patent Application Publication
(10) Pub. No.: US 2005/0194475 A1
(43) Pub. Date: Sep. 8, 2005

(54) Inductively coupled plasma chemical vapor deposition apparatus

(76) Inventors: Han-Ki Kim, Suwon-si (KR); Myung-Soo Huh, Suwon-si (KR); Myoung-Soo Kim, Seongnam-si (KR); Kyu-Sung Lee, Seoul (KR); Seok-Heon Jeong, Yongin-si (KR)

Correspondence Address: Robert E. Bushnell, Suite 300, 1522 K Street, N.W., Washington, DC, 20005-1202, US

(21) Appl. No.: 11/070,232

(22) Filed: Mar. 3, 2005

(30) Foreign Application Priority Data
Mar. 4, 2004 (KR) 2004-0014522
Apr. 26, 2004 (KR) 2004-0028571
May 10, 2004 (KR) 2004-0032688
May 19, 2004 (KR) 2004-0035684

(51) Int. Cl. B05B 5/025

(52) U.S. Cl. 239/690

(57) ABSTRACT

An inductively coupled plasma chemical vapor deposition apparatus comprises a reaction gas spray nozzle capable of evenly spraying reaction gas onto a rectangular substrate, a radio frequency (RF) antenna capable of uniformly forming a plasma source in a rectangular shape, and a rectangular mask maintained at a low temperature so as to uniformly form a thin film on the rectangular substrate used for a flat panel display device.

### CLAIM OF PRIORITY

This application makes reference to, incorporates the same herein, and claims all benefits accruing under 35 U.S.C. §119 from applications for INDUCTIVELY COUPLED PLASMA CHEMICAL VAPOR DEPOSITION APPARATUS earlier filed in the Korean Intellectual Property Office on 4 Mar. 2004, 26 Apr. 2004, 10 May 2004, and 19 May 2004 and there-duly assigned Serial No. 2004-14522, No. 2004-28571, No. 2004-32688 and No. 2004-35684, respectively.

### BACKGROUND OF THE INVENTION

1. Technical Field

The present invention relates to an inductively coupled plasma chemical vapor deposition apparatus and, more particularly, to an inductively coupled plasma chemical vapor deposition apparatus which includes a reaction gas spray nozzle capable of evenly spraying reaction gas onto a rectangular substrate, a radio frequency (RF) antenna capable of uniformly forming a plasma source in a rectangular shape, and a rectangular mask maintained at a low temperature so as to uniformly form a thin film on the rectangular substrate used for a flat panel display device.

2. Description of the Prior Art

As is generally known in the art, organic light emitting display devices, which are recently spotlighted as advanced flat panel display devices, have superior operational characteristics, such as self-luminance, wide viewing angle and high-speed response characteristics. An organic light emitting diode (OLED) used for the organic light emitting display device includes a first electrode (anode), an organic thin film consisting of a hole transport layer, an emitting layer and an electron transport layer, and a second electrode (cathode), which are formed on a glass substrate.

If voltage of a few volts is applied between the anode and the cathode, holes are generated from the anode and electrons are generated from the cathode. The holes and electrons are transported through the hole transport layer and the electron transport layer, respectively, and are coupled at the emitting layer, thereby generating excitons having high energy. While the excitons are returning to the ground state, light is generated with energy corresponding to the differential energy between the excited state and the ground state. Therefore, it is necessary to form an electrode layer together with other layers so as to supply electrons to the organic emitting layer of the organic light emitting diode.

The structure of the organic light emitting diode for the display device can be variously formed. For instance, the hole transport layer and the electron transport layer are simultaneously formed on the organic thin film, or only an electroluminescent layer is formed between two electrodes without forming the transport layers.

In a conventional bottom emission type organic light emitting display device, light is outputted from a substrate by passing through a transparent anode including a transparent electrode, such as ITO (Indium Tin Oxide). A metal, such as aluminum, is used as a cathode. Alternatively, a front emission type organic light emitting display device is used, in which light is discharged from a protective layer through a transparent or a semitransparent cathode. In this case, a transparent conductive layer, such as ITO, is used as a cathode, and an electron feed layer is further provided.

In any of these cases, a film forming process adaptable for a low temperature atmosphere and capable of reducing damage caused by particle collision is necessary in order to prevent the organic thin film layer from being damaged when the cathode electrode and the insulative layer are formed on the organic thin film after the organic thin film, including a bottom anode electrode and an organic emitting layer, has been formed on the substrate.

Studies haven been carried out with respect to the formation of a metal or a transparent electrode on the organic thin film through a direct current/radio frequency (DC/RF) sputtering process in order to form a conductive thin film on the substrate. However, according to the sputtering process, particles with high energy are generated when plasma is formed, and such particles may collide with a substrate, so that the temperature of an OLED organic film rises or the OLED organic film is deformed. In addition, the sputtering process may present problems such as re-sputtering for a substrate surface, an interfacial reaction, and creation of secondary electrons.

In addition, a plasma enhanced chemical vapor deposition (PECVD) process has been suggested so as to form an oxide thin film or a semiconductor thin film. However, since the PECVD process is carried out with temperatures above 400° C., the substrate may be damaged during the PECVD process.

In order to solve the above problems, inductively coupled plasma chemical vapor deposition (hereinafter, referred to as ICP-CVD) has been currently suggested in order to form a thin film for the OLED. According to the ICP-CVD process, a substrate is not influenced by an electric field generated by an RF antenna installed at an outer portion of a reaction chamber, and plasma is generated in the vicinity of the substrate, so that plasma is efficiently applied to the substrate while reducing plasma loss. Therefore, it is possible to form a thin film at a relatively low temperature through the ICP-CVD process.

However, an inductively coupled plasma chemical vapor deposition apparatus (hereinafter, referred to as an ICP-CVD apparatus) used for the ICP-CVD process is adaptable for a circular substrate. Accordingly, a problem may occur if the ICP-CVD apparatus is employed to form a thin film on a rectangular substrate used for flat panel display devices, such as OLEDs, PDPs, LCDs and FEDs. In addition, since the conventional ICP-CVD apparatus forms the thin film on the substrate while maintaining the substrate at a relatively high temperature, the conventional ICP-CVD apparatus is not adaptable to form the thin film on the substrate in a low temperature atmosphere. For this reason, the conventional ICP-CVD apparatus may cause problems in the operation of a reaction gas spray nozzle, a plasma antenna and a mask.

That is, since the conventional reaction gas spray nozzle sprays reaction gas onto the substrate from an upper center portion of the reaction chamber, reaction gas is unevenly sprayed between an edge area and a center area of the rectangular substrate, so that plasma uniformity is degraded. As a result, characteristics of the thin film formed on the substrate include lack of uniformity. In addition, since the conventional plasma antenna forms plasma in a circular pattern, plasma is unevenly formed at an edge area of the rectangular substrate. That is, according to the conventional plasma antenna having a spiral structure, a magnetic field is concentrated at a center area of the substrate, so that the center area of the substrate has a relatively higher plasma density and the edge area of the substrate has a relatively lower plasma density. For this reason, the characteristics of the thin film formed on the substrate include lack of uniformity. In addition, since the conventional mask formed with a thin film pattern is generally made from a metal or a ceramic material, the temperature of the mask may rise if the mask is exposed to plasma, so that the mask is thermally deformed. Such deformation of the mask makes it difficult to uniformly form the thin film pattern on the substrate. In addition, if the temperature of the mask rises, the temperature of the substrate aligned below the mask also rises, thereby causing deformation of the substrate.

### SUMMARY OF THE INVENTION

Accordingly, the present invention has been made to solve one or more of the above-mentioned problems occurring in the prior art, and the claimed invention is directed to providing an inductively coupled plasma chemical vapor deposition apparatus which includes a reaction gas spray nozzle capable of evenly spraying reaction gas onto a rectangular substrate, an RF antenna capable of uniformly forming a plasma source having a rectangular shape, and a rectangular mask maintained at a low temperature so as to uniformly form a thin film on the rectangular substrate used for a flat panel display device.

In order to accomplish this object, according to one aspect of the present invention, there is provided an inductively coupled plasma chemical vapor deposition apparatus comprising: a process chamber having a sealed cavity therein, and including an upper wall made from a dielectric material; an RF antenna installed at an outer portion of the process chamber adjacent to the upper wall of the process chamber, and receiving RF power from an RF power source; a gas spray nozzle section, including a central gas spray nozzle part installed at a center portion of the upper wall and positioned below the RF antenna, and an outer gas spray nozzle part installed at an upper portion of a chamber body of the process chamber; and a substrate fixing section installed at an inner lower portion of the process chamber so as to load a substrate thereon. The RF antenna has a rectangular shape and includes at least two positive electrode rods having linear shapes and aligned in parallel to each other on a same plane while forming a predetermine interval therebetween, at least one negative electrode rod having a linear shape and aligned on a same plane alternately with the positive electrode rods, a common terminal for electrically connecting a first end of the positive electrode rod to a first end of the negative electrode rod, a positive electrode terminal electrically connected to a second end of the positive electrode rod, and a negative electrode terminal electrically connected to a second end of the negative electrode rod. The negative electrode rod is aligned between the positive electrode rods or the positive electrode rod is aligned between the negative electrode rods. The positive electrode rod and the negative electrode rod are made from an oxygen free copper pipe, which is coated with Au or Ag. The positive electrode rod and the negative electrode rod are movably coupled to the common terminal such that the distance between the positive electrode rod and the negative electrode rod is adjustable.

According to the present invention, the gas spray nozzle section includes the central gas spray nozzle part installed at a center portion of the gas spray nozzle section so as to spray gas in a downward direction therefrom, and the outer gas spray nozzle part having a rectangular ring shape, in which each side of the outer gas spray nozzle part is spaced from the central gas spray nozzle part and gas is sprayed from an inner portion of the outer gas spray nozzle part, in a downward direction or a horizontal direction, and the outer gas spray nozzle part sprays the gas such that the gas is distributed around gas sprayed from the central gas spray nozzle part. The central gas spray nozzle part includes a support block having a gas feeding hole which is extended by passing through the support block and a coupling hole formed at a central lower portion of the support block and communicating with the gas feeding hole, and a central gas spray nozzle having a block shape, the central gas spray nozzle having a central hole formed at a center portion thereof, the central hole being extended by passing through the central gas spray nozzle and being coupled with the coupling hole of the support block. The central gas spray nozzle has a circular plate shape, and the central hole has a circular shape or a rectangular shape. The central gas spray nozzle has a rectangular plate shape, and the central hole has a circular shape or a rectangular shape. The outer gas spray nozzle part includes a body having a rectangular ring shape, in which each side of the body is formed with at least three perforated holes. The perforated holes are downwardly inclined from an outer peripheral portion to an inner peripheral portion of the body by a predetermined angle and directed toward a center of the body, and the perforated holes, except for the perforated holes aligned in each center portion of each side of the body, are biased in a left direction or a right direction by a predetermined angle. The outer gas spray nozzle part includes at least two bodies having a rectangular ring shape and stacked in a longitudinal direction thereof. The outer gas spray nozzle part includes a body having a rectangular ring shape. The body has an upper body section and a lower body section having a rectangular ring shape, the two sections being coupled to each other. A rectangular ring-shaped passage slot, communicating with outer portions of the upper body section or the lower body section, is formed at a lower surface of the upper body section or an upper surface of the lower body section, and at least three perforated holes communicating with the passage slot are connected to an inner portion of the upper body section or the lower body section.

In addition, the substrate fixing section includes: a chuck installed on an upper surface of the substrate and having a central vertical hole vertically extending from an upper center portion of the chuck to a lower center portion of the chuck by passing through the chuck, and upper slots for connecting the central vertical hole to both side portions of the chuck; a mask installed on the upper surface of the substrate and having a thin film pattern formed on the substrate; and a clamp installed at both upper side portions of the chuck so as to fix the mask to an upper portion of the substrate. The upper slots include at least three horizontal upper slots horizontally formed in parallel to each other between both side portions of the chuck while forming a predetermined interval therebetween, and a vertical upper slot for connecting the horizontal upper slots with each other. The upper slots are formed radially outward from the central vertical hole to both side portions and upper and lower portions of the chuck. Outer vertical holes extend from the upper portion of the chuck to the lower portion of the chuck by passing through the chuck while being spaced from both side portions of the chuck by a predetermined distance such that the outer vertical holes communicate with the upper slots. The mask includes a mask body formed with a thin film pattern and a mask frame provided at both side ends of the mask body. The clamp includes a front fixing section protruding from a front end of the clamp toward a center portion of the check and making contact with an upper surface of the mask so as to fix the mask, and a fixing groove formed at a lower portion of the clamp and coupled with the mask frame so as to support the mask. The clamp further includes a fixing spring which is fixed to an upper portion of the fixing groove, and which makes contact with an upper surface of the mask frame so as to support the mask. The fixing spring comprises a leaf spring or a coil spring.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematically sectional view illustrating an ICP-CVD apparatus according to one embodiment of the present invention;

FIG. 2 is a plan view illustrating an RF antenna according to one embodiment of the present invention;

FIG. 3 is a front view of the RF antenna shown in FIG. 2;

FIG. 4 is a plan view illustrating a large area RF antenna, including two RF antennas as shown in FIG. 2;

FIG. 5a is a sectional view illustrating a central gas spray nozzle according to one embodiment of the present invention;

FIG. 5b is a bottom view of the central gas spray nozzle shown in FIG. 5a;

FIGS. 5c to 5e are bottom views of central gas spray nozzles according to other embodiments of the present invention;

FIG. 6a is a perspective view illustrating an outer gas spray nozzle according to one embodiment of the present invention;

FIG. 6b is a longitudinally sectional view of the outer gas spray nozzle shown in FIG. 6a;

FIG. 6c is a sectional view taken along line A-A shown in FIG. 6b;

FIG. 7 is a sectional view illustrating an outer gas spray nozzle according to another embodiment of the present invention;

FIG. 8a is a cross sectional view illustrating an outer gas spray nozzle according to still another embodiment of the present invention;

FIG. 8b is a sectional view taken along line B-B shown in FIG. 8a;

FIG. 9 is a longitudinally sectional view of an outer gas spray nozzle according to still another embodiment of the present invention;

FIG. 10a is a plan view illustrating the direction of reaction gas sprayed from a gas spray nozzle according to one embodiment of the present invention;

FIG. 10b is a schematic view illustrating the direction of reaction gas sprayed from an ICP-CVD apparatus equipped with a gas spray nozzle as shown in FIG. 10a according to one embodiment of the present invention;

FIG. 11a is a sectional view illustrating a substrate fixing section according to one embodiment of the present invention;

FIG. 11b is a sectional view illustrating a substrate fixing section according to another embodiment of the present invention;

FIG. 12 is a plan view illustrating a chuck used in a substrate fixing section according to one embodiment of the present invention;

FIG. 13 is a plan view illustrating a chuck according to another embodiment of the present invention;

FIG. 14 is a plan view illustrating a chuck according to still another embodiment of the present invention;

FIG. 15 is a plan view illustrating a substrate fixing section according to still another embodiment of the present invention; and

FIG. 16 is a plan view illustrating a substrate fixing section according to still another embodiment of the present invention.

### DETAILED DESCRIPTION OF THE INVENTION

Hereinafter, embodiments of the present invention will be described with reference to the accompanying drawings. In the following description and drawings, the same reference numerals are used to designate the same or similar components, and so repetition of the description of the same or similar components will be omitted.

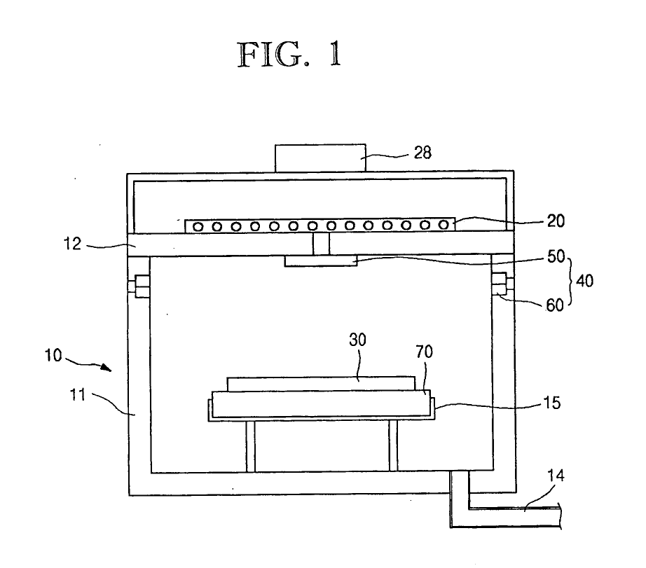

FIG. 1 is a schematically sectional view illustrating an ICP-CVD apparatus according to one embodiment of the present invention.

Referring to FIG. 1, the ICP-CVD apparatus according to one embodiment of the present invention includes a process chamber 10 formed at an inner portion thereof with a sealed cavity and having a chamber body 11, and walls, at least one of which (herein, an upper wall 12) is made from a dielectric material, an RF antenna 20 installed at an outer portion of the process chamber 10 adjacent to the upper wall 12 of the process chamber 10, an RF power source 28 for applying RF power to the RF antenna 20, a gas spray nozzle section 40 including a central gas spray nozzle part 50 installed at a center of the upper wall 12 and aligned with a lower portion of the RF antenna 20 and an outer gas spray nozzle part 60 installed at an upper portion of the chamber body 11 of the process chamber 10, and a substrate fixing section 70 installed at a lower inner portion of the process chamber 10 with a substrate 30 being loaded thereon. The substrate 30 is a rectangular planar substrate used for a flat panel display device.

The chamber body 11 has sidewalls and a bottom wall, and the upper wall 12 covers the chamber body 11 so as to form the sealed cavity in the process chamber 10 in such a manner that an ICP-CVD process can be performed with respect to the substrate 30 in the process chamber 10. At least one of the walls of the process chamber 10 (herein, the upper wall 12) is made from a dielectric material, such as Al₂O₃, AlN, quartz, or anodized Al. The upper wall 12 can be integrally/separately formed with/from the chamber body 11. In addition, sidewalls of the chamber body 11 can be made from the dielectric material.

The substrate 30, on which a thin film is formed, is loaded on an upper surface of the substrate fixing section 70 installed at the inner lower portion of the process chamber 10. In addition, a vacuum line 14 is connected to the process chamber 10 so as to maintain the process chamber 10 in a vacuum state. The vacuum line 14 is connected to a vacuum pump (not shown). When the vacuum pump operates, the process chamber 10 is maintained in the vacuum state at about 1 mTorr to 100 mTorr.

The RF antenna 20 is installed on an upper portion of the upper wall 12. The RF antenna 20 receives RF power from the RF power source 28, thereby forming a magnetic field in an upper portion of the process chamber 10. Accordingly, plasma is generated between the upper portion of the process chamber 10 and the upper surface of the substrate 30 due to the magnetic field generated by the RF antenna 20.

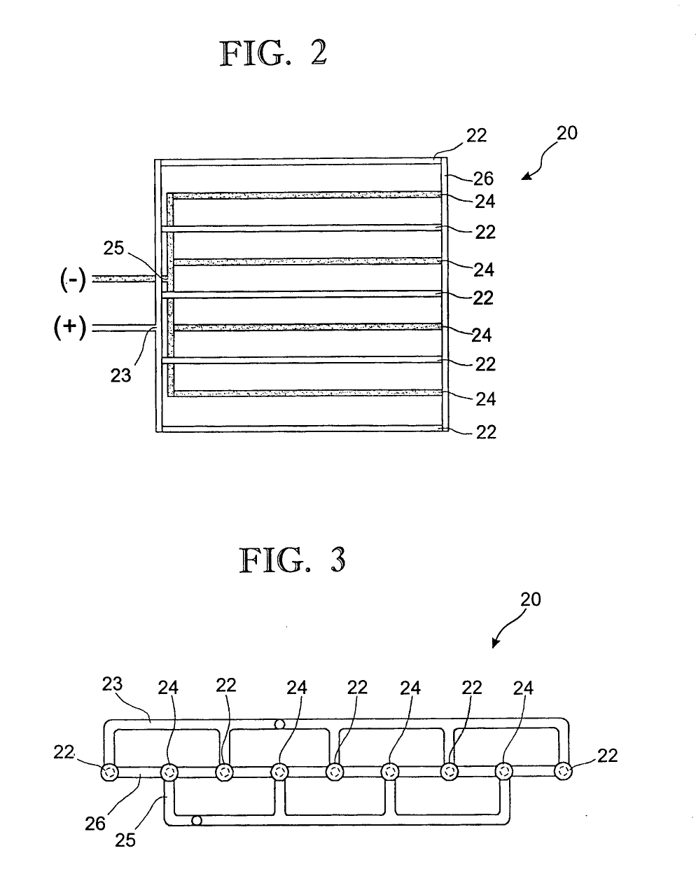

FIG. 2 is a plan view illustrating an RF antenna according to one embodiment of the present invention.

Referring to FIG. 2, the RF antenna 20 has a rectangular shape and includes a plurality of positive electrode rods 22, a plurality of negative electrode rods 24, a common terminal 26, a positive electrode terminal 23 and a negative electrode terminal 25. As shown in FIG. 2, the RF antenna 20 may have five positive electrode rods 22 and four negative electrode rods 24. However, this is for illustrative purposes only, and the present invention is not limited to the number of positive electrode rods 22 and negative electrode rods 24.

The positive electrode rods 22 and negative electrode rods 24 have linear shapes. Each positive electrode rod 22 has a pipe structure formed at an inner portion thereof with a cooling water passage. The positive electrode rod 22 is made from an oxygen-free copper pipe having superior electric conductivity so as to minimize resistance loss of current flowing through the positive electrode rod 22. Preferably, Ag or Au can be coated on the oxygen-free copper pipe in order to minimize resistance loss of the positive electrode rod 22. However, the present invention is not limited to the material for the positive electrode rod 22 so long as it has electric conductivity similar to that of the oxygen-free copper pipe.

The positive electrode rods 22 are aligned in parallel to each other in substantially the same plane while forming a predetermined interval therebetween. First ends of the positive electrode rods 22 are electrically connected to the RF power source 28 through the positive electrode terminal 23. In addition, second ends of the positive electrode rods 22 are electrically connected to the common terminal 26. Therefore, the positive electrode rods 22 are aligned between the positive electrode terminal 23 and the common terminal 26 while forming a predetermined interval therebetween.

In addition, in order to adjust the interval between the positive electrode rods 22, the positive electrode rods 22 can be movably coupled to the positive electrode terminal 23 and the common terminal 26 when the positive electrode rods 22 are connected to the positive electrode terminal 23 and the common terminal 26. For instance, the positive electrode rods 22 can be coupled to the common terminal 26 by means of a clamp (not shown) so as to easily shift the position of the positive electrode rods 22, if necessary.

The negative electrode rods 24 are aligned in substantially the same plane and are arranged alternately with the positive electrode rods 22. Preferably, the negative electrode rods 24 are aligned between the positive electrode rods 22. That is, the number of negative electrode rods 24 is less than the number of positive electrode rods 22 by one. Accordingly, since the positive electrode rods 22 are installed on both sides of the RF antenna 20, current is evenly applied to the RF antenna 20 so that density of the magnetic field is also evenly formed.

First ends of the negative electrode rods 24 are connected to the negative electrode terminal of the RF power source 28 or to a ground section through the negative electrode terminal 25. In addition, the second ends of the negative electrode rods 24 are connected to the common terminal 26, to which second ends of the positive electrode rods 22 are connected. Therefore, the negative electrode rods 24 are aligned between the negative electrode terminal 25 and the common terminal 26 in parallel with each other, while forming a predetermined interval therebetween. In order to adjust the interval between the negative electrode rods 24, the negative electrode rods 24 can be movably coupled to the negative electrode terminal 25 and the common terminal 26 when the negative electrode rods 24 are connected to the negative electrode terminal 25 and the common terminal 26. For instance, the negative electrode rods 24 can be coupled to the common terminal 26 by means of a clamp so as to easily shift the position of the negative electrode rods 24, if necessary.

In addition, it is also possible to align the negative electrode rods 24 at both sides of the RF antenna 20. In this case, the number of negative electrode rods 24 is more than the number of positive electrode rods 22 by one, and the positive electrode rods 22 are aligned between the negative electrode rods 24.

The common terminal 26 is made of an electric conductor, such as an oxygen free copper pipe used for the positive electrode rod 22 or an electrically conductive wire. The common terminal 26 electrically connects the second ends of the positive electrode rods 22 to the second ends of the negative electrode rods 24 so that current supplied to each positive electrode rod 22 may uniformly flow to each negative electrode rod 24.

The positive electrode terminal 23 is made of an electric conductor, such as an oxygen free copper pipe used for the positive electrode rod 22 or an electrically conductive wire. The positive electrode terminal 23 is electrically connected to first ends of the positive electrode rods 22 and to a positive electrode of the RF power source 28 so as to supply RF power to the positive electrode rods 22.

The negative electrode terminal 25 is made of an electric conductor, such as an oxygen free copper pipe used for the negative electrode rod 24 or an electrically conductive wire. The negative electrode terminal 25 is electrically connected to first ends of the negative electrode rods 24 and to a negative electrode of the RF power source 28 or the ground section.

FIG. 3 is a front view of the RF antenna shown in FIG. 2.

Referring to FIG. 3, the positive electrode terminal 23 of the RF antenna 20 is positioned at an upper portion, and the negative electrode terminal 25 of the RF antenna 20 is positioned at a lower portion. In this case, the length of the positive electrode rod 22 is substantially equal to the length of the negative electrode rod 24 so that the RF antenna 20 can uniformly form a plasma source having a rectangular shape.

When RF power is applied to the positive electrode rods 22 of the RF antenna 20 through the positive electrode terminal 23 connected to the RF power source 28, current is uniformly applied to each positive electrode rod 22. The current flowing through the positive electrode rods 22 is introduced into the negative electrode rods 24 aligned between the positive electrode rods 22 through the common terminal 26. Accordingly, each positive electrode rod 22 may form an electric field together with each negative electrode rod 22 aligned adjacent to the positive electrode rod 22. Plasma is generated in the process chamber 10 due to the formed electric fields. Since the electric fields have the same size, each electric field has the same density so that the plasma source is uniformly formed by means of the RF antenna 20. Since the RF antenna 20 has the same shape and size compared to the size and shape of the rectangular substrate 30, the plasma source is uniformly formed on the upper surface of the rectangular substrate 30.

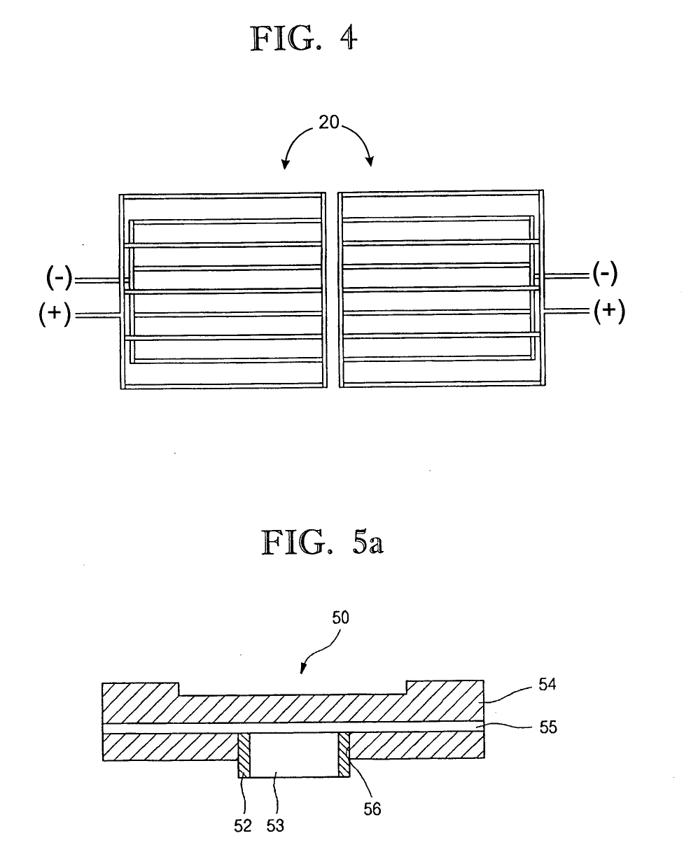

FIG. 4 is a plan view illustrating a large area RF antenna, including two RF antennas as shown in FIG. 2.

As shown in FIG. 4, a plurality of RF antennas 20 can be coupled in parallel to each other so as to form a large-area RF antenna. In this case, the plasma source can be formed in a relatively large area so that it is possible to form thin films at the same time on a plurality of substrates having a relatively large area.

Referring to FIG. 1, the gas spray nozzle section 40 includes the central gas spray nozzle part 50 and the outer gas spray nozzle part 60.

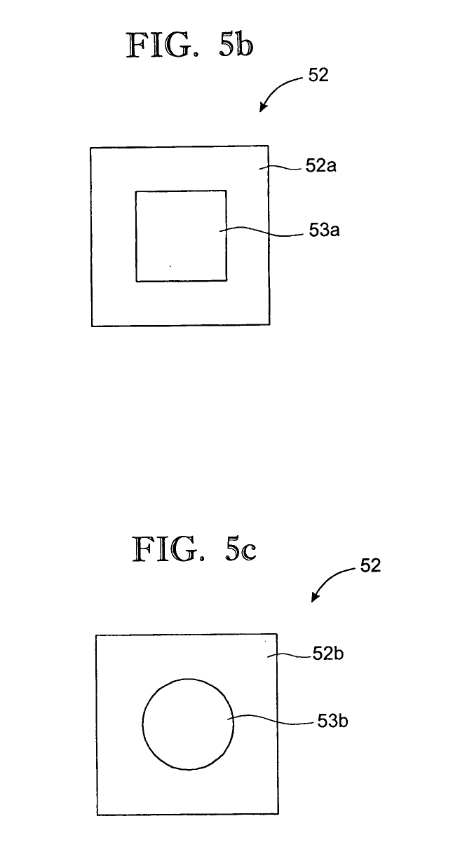

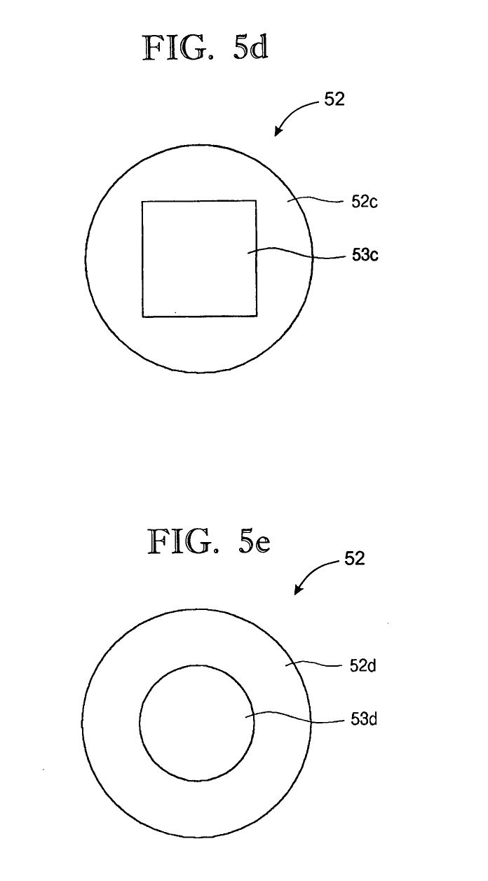

FIG. 5a is a sectional view illustrating a central gas spray nozzle according to one embodiment of the present invention, FIG. 5b is a bottom view of the central gas spray nozzle shown in FIG. 5a, and FIGS. 5c to 5e are bottom views of central gas spray nozzles according to other embodiments of the present invention.

Referring to FIG. 5a, the central gas spray nozzle part 50 includes a central gas spray nozzle 52 and a support block 54 for supplying gas while supporting the central gas spray nozzle 52.

The central gas spray nozzle 52 is a block in which a central hole 53 is formed. The central gas spray nozzle 52 is coupled to a lower portion of the support block 54. Referring to FIG. 5b, the central gas spray nozzle 52 includes a rectangular block 52a having a rectangular central hole 53a. However, the present invention is not limited to the shape of the central gas spray nozzle 52. For instance, the central gas spray nozzle 52 can be formed with various shapes as shown in FIGS. 5c to 5e. That is, referring to FIG. 5c, the central gas spray nozzle 52 comprises a rectangular block 52b having a central hole 53b formed at a center thereof. Referring to FIG. 5d, the central gas spray nozzle 52 comprises a circular block 52c having a rectangular hole 53c formed at a center thereof. Referring to FIG. 5e, the central gas spray nozzle 52 comprises a circular block 52d having a circular hole 53d formed at a center thereof.

In order to uniformly form the thin film over the entire area of the rectangular glass substrate 30 of FIG. 1, the central gas spray nozzle part 50 must be provided with the outer gas spray nozzle part 60 in such a manner that gas can be sprayed with uniform distribution according to the process condition. Therefore, the central gas spray nozzle 52 of the central gas spray nozzle part 50 has a structure adaptable for gas distribution by the outer gas spray nozzle part 60.

The support block 54 of FIG. 5a has a rectangular shape or a circular shape. The support block 54 has a gas feeding hole 55 formed at one side thereof, and an upper portion of the support block 54 is coupled to a lower portion of the upper wall of the process chamber 10. The support block 54 has a coupling hole 56 formed at a lower portion thereof, and the coupling hole 56 communicates with the gas feeding hole 55 and is coupled to the central gas spray nozzle 52. Accordingly, when the central gas spray nozzle 52 is inserted into the coupling hole 56, the gas feeding hole 55 communicates with the central hole 53 of the central gas spray nozzle 52. Thus, reaction gas supplied to the gas feeding hole 55 through an external gas pipe is fed into the central hole 53 of the central gas spray nozzle 52, and is sprayed in a downward direction.

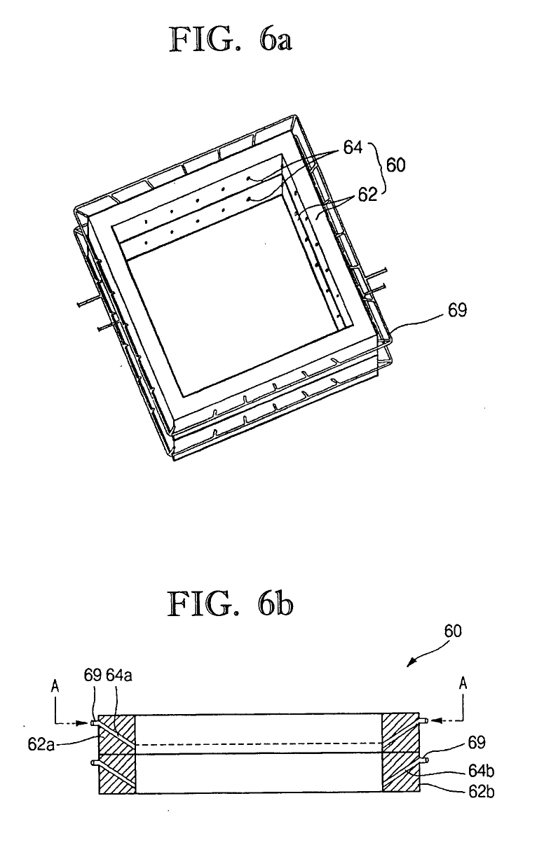

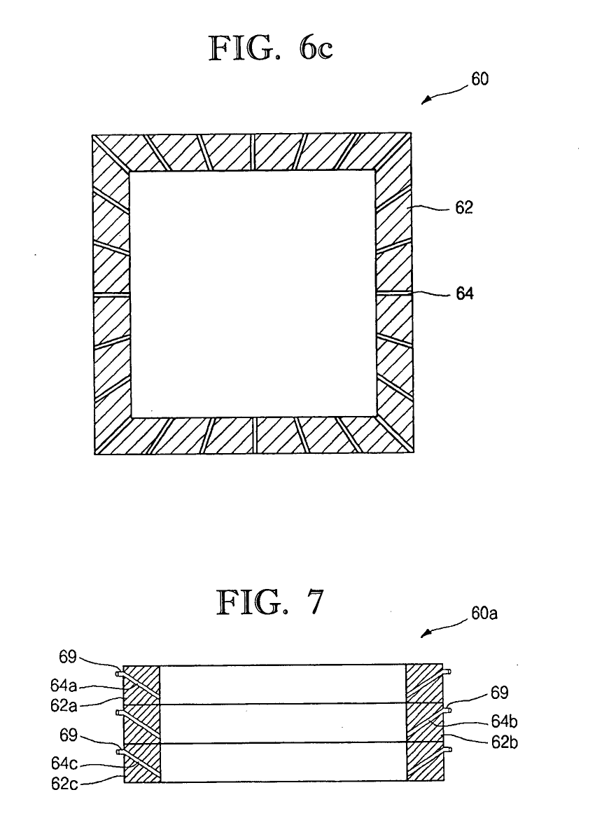

FIG. 6a is a perspective view illustrating an outer gas spray nozzle according to one embodiment of the present invention, FIG. 6b is a longitudinally sectional view of the outer gas spray nozzle shown in FIG. 6a, and FIG. 6c is a sectional view taken along line A-A shown in FIG. 6b.

Referring to FIGS. 6a to 6c, the outer gas spray nozzle part 60 includes a body 62 having a rectangular ring shape (hereinafter, referred to as a rectangular body). A gas pipe 69 is formed at an outer portion of the rectangular body 62 for feeding gas. The outer gas spray nozzle part 60 is installed on the upper wall of the chamber body 11 (FIG. 1) of the process chamber 10.

The outer gas spray nozzle part 60 (FIGS. 6a to 6c) includes perforated holes 64 which are perforated from each outer wall to each inner wall of the rectangular body 62. Preferably, the perforated holes 64 are downwardly inclined from an upper portion of an outer peripheral portion of the rectangular body 62 toward a lower portion of an inner peripheral portion of the rectangular body 62 at a predetermined angle. In addition, when viewed from the top, the perforated holes 64 are directed toward the center of the rectangular body 62 of the outer gas spray nozzle part 60. That is, except for the perforated holes 64 aligned in each center portion of each side of the rectangular body 62, the holes 64 are biased in a left direction or a right direction by a predetermined angle. The bias angles of the perforated holes 64 become enlarged as they are remote from the center portion of each side of the rectangular body 62. At least three perforated holes 64 are formed in each side of the rectangular body 62. The number of perforated holes 64 may vary depending on the amount of gas to be fed. In addition, perforated holes 64 can be formed at each corner portion of the rectangular body 62 toward the center of the rectangular body 62. The gas pipe 69 is connected to an outer end of the perforated holes 64 so as to feed gas into the rectangular body 62 in such a manner that the gas is sprayed through an inner end of the perforated holes 64.

The gas is sprayed in a downward direction through the perforated holes 64 so that the gas is sprayed onto the upper surface of the substrate 30 disposed at a lower portion of the process chamber 10. Preferably, the gas is concentrated on an outer peripheral portion of the substrate 30. Since the substrate 30 has a rectangular shape corresponding to the shape of the outer gas spray nozzle part 60, the gas can be uniformly sprayed onto corner portions of the substrate 30.

The outer gas spray nozzle part 60 may include at least two rectangular bodies 62 which are stacked in a longitudinal direction thereof.

FIG. 7 is a sectional view illustrating an outer gas spray nozzle according to another embodiment of the present invention.

That is, FIG. 7 shows an outer gas spray nozzle part 60a including three rectangular bodies 62a, 62b and 62c. If the outer gas spray nozzle part 60 includes at least two rectangular bodies 62a, 62b and/or 62c, gas can be individually sprayed from each rectangular body 62a, 62b and/or 62c. Therefore, even if various reaction gases are used, the reaction gases are prevented from reacting with each other at the gas pipes 69 or in the perforated holes 64 of the rectangular body 62, thereby preventing the reaction gases from being deposited in the gas pipes 69 or preventing the nozzle from clogging. Accordingly, the outer gas spray nozzle part 60 may include a plurality of rectangular bodies 62a, 62b and/or 62c depending on the sort of reaction gases to be used. In addition, it is also possible to feed the various reaction gases into the gas pipes 69 connected to the perforated holes 64 in such a manner that the different types of gases can be fed into each gas pipe 69.

The inclined angles of the perforated holes 64 formed in each rectangular body 62 may be different from each other. For instance, inclined angles of perforated holes 64a formed in an upper rectangular body 62a may be steeper than those of the perforated holes 64b formed in a lower rectangular body 62b so as to allow the outer gas spray nozzle part 60 to uniformly spray gas onto the substrate 30.

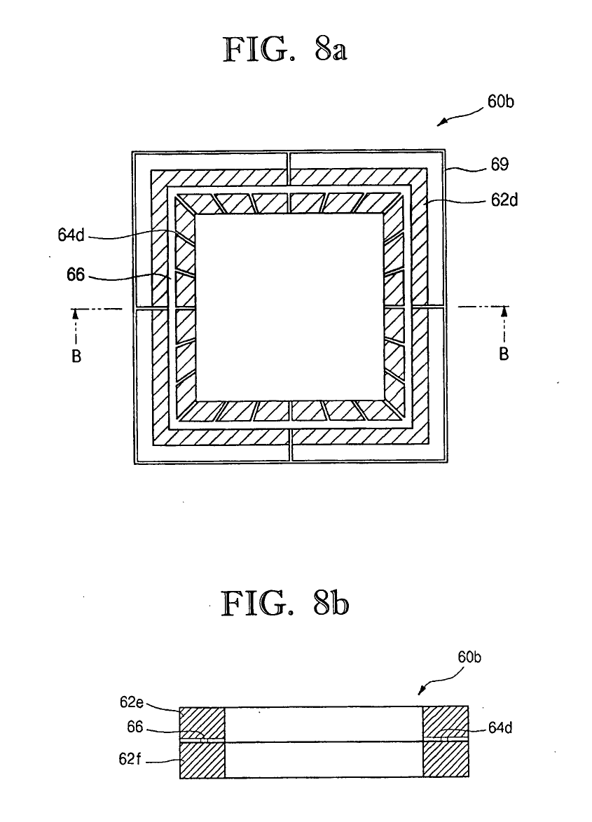

FIG. 8a is a cross sectional view illustrating an outer gas spray nozzle according to still another embodiment of the present invention, and FIG. 8a is a cross sectional view illustrating an outer gas spray nozzle according to still another embodiment of the present invention.

That is, FIGS. 8a and 8b show an outer gas spray nozzle 60b according to another embodiment of the present invention. The outer gas spray nozzle 60b includes a body 62d having a rectangular ring shape (hereinafter, refereed to as a rectangular body), a passage slot 66 formed in the rectangular body 62d and having a shape corresponding to the shape of the rectangular body 62d, and perforated holes 64d communicating with an inner portion of the rectangular body 62d. The passage slot 66 communicates with predetermined outer portions of the rectangular body 62d. That is, the rectangular body 62d includes an upper body 62e and a lower body 62f, in which the passage slot 66 and the perforated holes 64d are formed on a lower surface of the upper body 62e or an upper surface of the lower body 62f. Accordingly, when the upper body 62e is coupled to the lower body 62f, the passage slot 66 and the perforated holes 64d are formed in the rectangular body 62 so as to feed gas through the passage slot 66 and the perforated holes 64d. In this case, the gas pipes 69 can be easily formed at the outer portion of the rectangular body 62d.

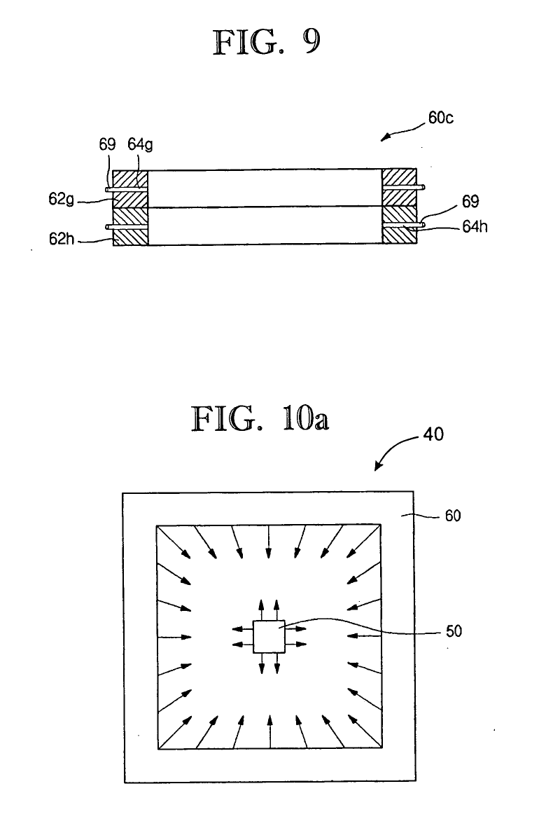

FIG. 9 is a longitudinally sectional view of an outer gas spray nozzle according to still another embodiment of the present invention.

That is, FIG. 9 shows an outer gas spray nozzle 60c according to still another embodiment of the present invention. The outer gas spray nozzle 60c includes a body 62g having a rectangular ring shape (hereinafter, refereed to as a rectangular body) and perforated holes 64g formed in the rectangular body 62g in a horizontal direction from an outer portion of the rectangular body 62g to an inner portion of the rectangular body 62g. In this case, gas is horizontally sprayed from the outer gas spray nozzle 60c toward the center of the rectangular body 62g, and is directed onto the substrate 30 placed below the gas spray nozzle section 40 together with the gas sprayed from the central gas spray nozzle part 50.

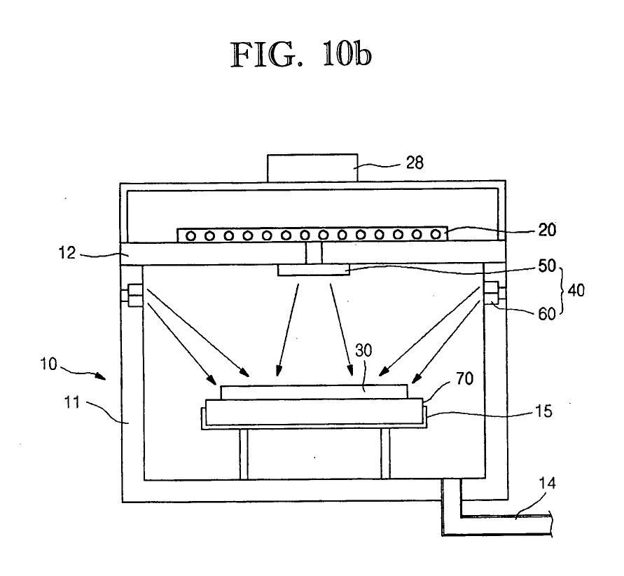

FIG. 10a is a plan view illustrating the direction of reaction gas sprayed from a gas spray nozzle section according to one embodiment of the present invention, and FIG. 10b is a sectional view illustrating the direction of reaction gas sprayed from an ICP-CVD apparatus equipped with the gas spray nozzle section as shown in FIG. 10a according to one embodiment of the present invention.

Referring to FIG. 10a, in the gas spray nozzle section 40, which includes the central gas spray nozzle part 50 and the outer gas spray nozzle part 60 having at least one rectangular body 62 (FIG. 6a), the central gas spray nozzle part 50 sprays the reaction gas downwardly in a substantially vertical direction. In addition, since the outer gas spray nozzle part 60 sprays the reaction gas at a predetermined inclination angle which becomes enlarged as it is displaced from the center of each side of the rectangular body 62, the reaction gas is sprayed in a downward direction of the rectangular body 62 toward the corner portions of the substrate 30. Accordingly, the reaction gas sprayed from the gas spray nozzle section 40 is uniformly distributed over the entire area of the substrate 30 disposed at the lower portion of the process chamber 10.

Meanwhile, the central gas spray nozzle part 50 mainly sprays reaction gas, while the outer gas spray nozzle part 60 sprays cleaning gas for cleaning an interior of the process chamber 10, in addition to the reaction gas. If the outer gas spray nozzle part 60 includes at least two rectangular bodies 62 (FIG. 6a), mutually different gases can be discharged from the rectangular bodies 62. For instance, referring to FIG. 6b, CF₄ gas can be discharged from the upper rectangular body 62a so as to clean the nozzle or remove materials deposited on an inner portion of the process chamber 10, and reaction gases, such as SiH₄, N₂, NO₂, NH₃, O₂, He, Xe and Ar gases, can be discharged from the lower rectangular body 62b. As shown in FIG. 7, if the outer gas spray nozzle part 60a includes three rectangular bodies 62a, 62b and 62c, the rectangular bodies 62b and 62c can spray different kinds of reaction gases, such as SiH4 and Ar, respectively. Therefore, the gas spray nozzle section 40 (FIG. 1) of the present invention can prevent reaction gases from reacting with each other in the gas pipes or perforated holes of the rectangular body, thereby preventing the pipes or nozzles from clogging.

Hereinafter, the operation of the ICP-CVD apparatus equipped with the gas spray nozzle system according to the present invention will be described with reference to FIG. 10b.

The central gas spray nozzle part 50 is installed at a lower portion of the upper wall 12 of the process chamber 10, and the outer gas spray nozzle part 60 is installed at the sidewall 11 of the process chamber 10. The substrate 30, on which the thin film is formed, is placed on the upper portion of the substrate fixing section 70 disposed at a lower portion of the process chamber 10. The vacuum pump (not shown) connected to the vacuum line 14 is operated so as to maintain the process chamber 10 in a vacuum state such that the reaction gas is sprayed through the gas spray nozzle section 40. The reaction gas sprayed through the gas spray nozzle section 40 is uniformly sprayed onto the center and corner portions of the substrate 30. Particularly, since the outer gas spray nozzle 60 has a rectangular ring shape, the reaction gas can be uniformly sprayed onto each edge of the rectangular substrate 30 used for a flat panel display device. If RF power is applied through the RF power source 28 to the RF antenna 20 disposed in the upper portion of the process chamber 10, a magnetic field is generated in the upper portion of the process chamber 10 so that plasma is formed in the process chamber 10 due to the magnetic field. Accordingly, a thin film is deposited on the substrate 30 disposed on the substrate fixing section 70 of the process chamber 10. Since the reaction gas is uniformly sprayed onto the center and edge portions of the substrate 30 by means of the gas spray nozzle section 40, the thin film can be uniformly formed over the entire area of the substrate 30.

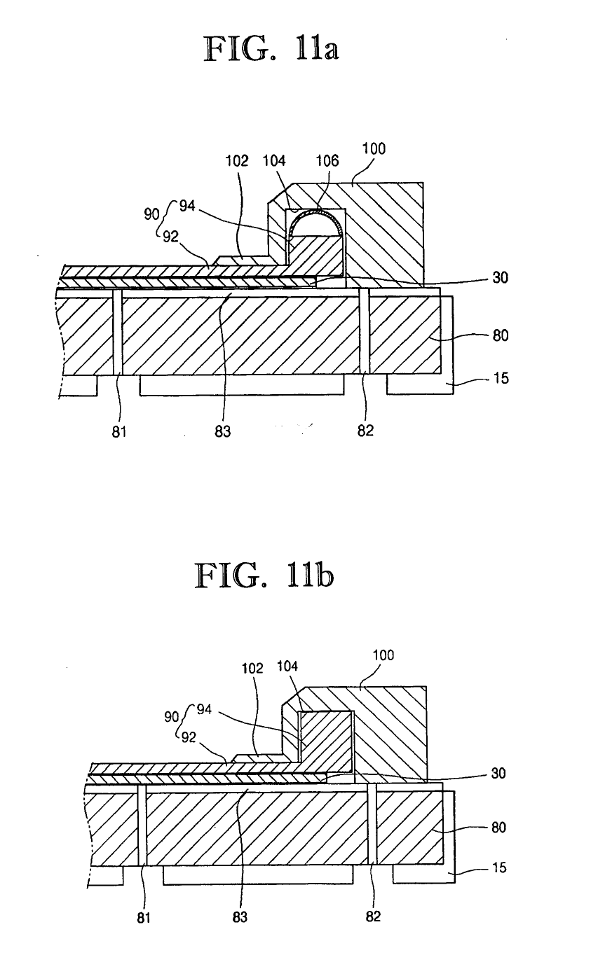

FIG. 11a is a sectional view illustrating a substrate fixing section according to one embodiment of the present invention, and FIG. 11b is a sectional view illustrating a substrate fixing section according to another embodiment of the present invention.

Referring to FIGS. 11a and 11b, the substrate fixing section 70 includes a chuck 80 for loading the substrate 30 having the thin film pattern thereon, a mask 90 resting on the upper surface of the substrate 30, and a clamp 100 for fixing the mask 90 to the chuck 80. In addition, the substrate fixing section 70 includes a fixing spring 106 installed in the clamp 100 so as to bias the mask 90 toward the substrate 30.

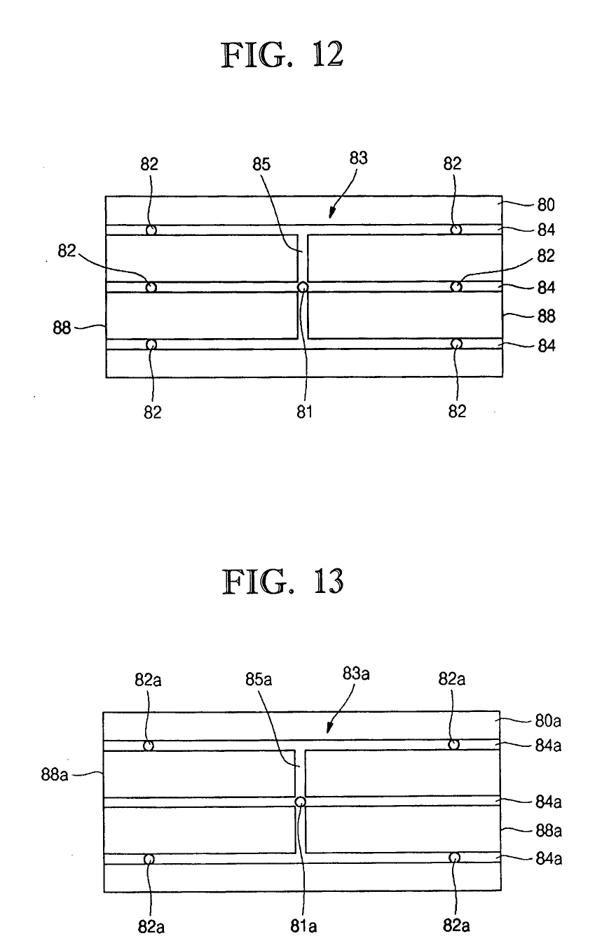

FIG. 12 is a plan view illustrating a chuck used in a substrate fixing section according to one embodiment of the present invention.

Referring to FIG. 12, the chuck 80 has a plate-shaped block structure of a predetermined size. Preferably, the chuck 80 has a rectangular block shape corresponding to the shape of the substrate 30 resting on the chuck 80. The chuck 80 has a central vertical hole 81, outer vertical holes 82, and upper slots 83. The chuck 80 is installed on a chuck supporter 15 provided in the process chamber 10.

The central vertical hole 81 extends vertically from an upper center portion of the chuck 80 to a lower center portion of the chuck 80 by passing through the chuck 80. A gas feeding pipe (not shown) is connected to a lower portion of the central vertical hole 81 so as to feed cooling gas upwardly through the chuck 80.

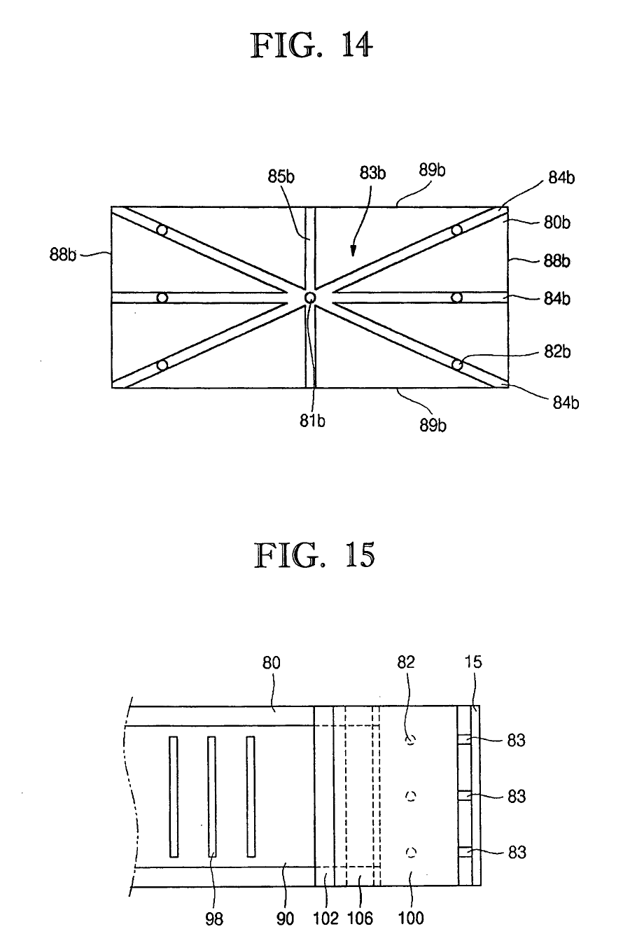

The outer vertical holes 82 extend from the upper portion of the chuck 80 to the lower portion of the chuck 80 by passing through the chuck 80 while being spaced apart from both side portions 88 of the chuck 80 by a predetermined distance. Preferably, as shown in FIGS. 11a and 14, the outer vertical holes 82 are formed in correspondence to a lower portion of the clamp 90 fixed to the upper portion of the chuck 80.

The upper slots 83 (FIG. 12) are formed to a predetermined depth on the upper surface of the chuck 80. The upper slots 83 include horizontal upper slots 84 horizontally formed between both side portions 88, and a vertical upper slot 85 connecting the horizontal upper slots 84 with each other. According to the present invention, at least three horizontal upper slots 84 are aligned in parallel to each other while having a predetermined interval therebetween. However, the number of horizontal upper slots 84 can be increased, if necessary. In addition, the upper horizontal slots 84 and the upper vertical slot 85 are connected to the central vertical hole 81 at an upper portion of the central vertical hole 81. Therefore, the upper slots 83 communicate with the central vertical hole 81 so that the cooling gas is fed to the upper slots 83 through the central vertical hole 81. In addition, outer vertical holes 82 are formed at both side portions of the upper horizontal slots 84 so that the outer vertical holes 82 communicate with each other through the upper horizontal slots 84. Accordingly, when the substrate 30 is loaded onto the upper slots 83, the upper slots 83 may form a horizontal passage together with the substrate 30 so that the cooling gas supplied by the central vertical hole 81 and the outer vertical holes 82 can be introduced into the entire area of the upper surface of the chuck 80 through the upper slots 83 of the chuck 80 while making contact with the substrate 30, thereby cooling the substrate 30 and the mask 90.

FIG. 13 is a plan view illustrating a chuck according to another embodiment of the present invention.

Referring to FIG. 13, the chuck 80a can have a reduced number of outer vertical holes if the cooling effect is sufficient. That is, the chuck 80a has no outer vertical holes at center parts of both side portions 88. Other elements of the chuck 80a are identical to those of the chuck 80 shown in FIG. 12, and so they will not be further described below.

FIG. 14 is a plan view illustrating a chuck according to still another embodiment of the present invention.

Referring to FIG. 14, the chuck 80b includes upper slots 83b extending radially outward from a central vertical hole 81b to both side portions 88b and upper and lower portions 89b of the chuck 80b. In this case, the cooling gas can be uniformly fed through each upper slot 83b. Other elements of the chuck 80b are identical to those of the chuck 80 shown in FIG. 12, and so they will not be further described below.

Referring back to FIGS. 11a and 11b, the mask 90 includes a mask body 92 having a thin film pattern to be formed on the upper surface of the substrate 30, and a mask frame 94 provided at both lateral end portions of the mask body 92.

The mask body 92 is made of a metal plate or a ceramic plate having a predetermined size capable of covering the upper surface of the substrate 30 resting on the chuck 80 so as to form the thin film pattern thereon. As mentioned above, the mask body 92 has a thin film pattern so as to form the thin film pattern on the upper surface of the substrate 30.

The mask frame 94 has a bar shape, and upwardly protrudes along both side ends of the mask body 92. The mask frame 94 is coupled to the clamp 100 so as to fix the mask body 92 to the substrate 30. As shown in FIG. 11a, the mask frame 94 can be formed with a bar shape having a rectangular sectional shape, a semicircular sectional shape, or a polygonal sectional shape. The length of the mask frame 94 may vary depending on the shape of the clamp 100.

FIG. 15 is a plan view illustrating a substrate fixing section according to still another embodiment of the present invention.

As shown in FIG. 15, the clamp 100 has a block shape and includes a front fixing section 102, a fixing groove 104 (see FIG. 11a), and a fixing spring 106. The clamp 100 is coupled to an upper portion of the chuck 80 or the chuck supporter 15 in order to fix the mask 90 to the upper portion of the substrate 30. As shown in FIG. 11b, the fixing spring 106 can be omitted if it is not necessary to precisely couple the mask frame 94 to the fixing groove 104.

Preferably, the length of the clamp 100 is equal to the length of the mask 90. Accordingly, the clamp 100 has a length sufficient to fix the lateral portion of the mask body 92. In addition, the surface of the clamp 100 is aluminum-anodized such that heat transferred to the clamp 100 from the mask 90 can be rapidly emitted through the clamp 100, thereby improving the cooling effect of the mask 90.

The front fixing section 102 protrudes from a front end of the clamp 100 by a predetermined distance such that a lower surface of the front fixing section 102 makes contact with an upper surface of the mask body 92.

The fixing groove 104 (FIGS. 11a and 11b) is formed at a lower portion of the clamp 100 and has a predetermined shape corresponding to a position of the mask frame 94. Preferably, the fixing groove 104 has a shape corresponding to the shape of the upper portion of the mask frame 94. That is, the fixing groove 104 has a rectangular shape if the mask frame has the rectangular sectional shape. In this case, the mask frame 94 is easily coupled to the fixing groove 104 so that the mask 90 can be easily fixed.

The fixing spring 106 (FIGS. 11a, 11b and 15) includes a leaf spring. The fixing spring 106 is fixed to an upper portion of the fixing groove 104 of the clamp 100 by means of a fixing unit (not shown), such as a bolt. Accordingly, the fixing spring 106 makes contact with the upper portion of the mask frame 94 when the mask frame 94 is inserted into the fixing groove 104, while biasing the mask frame 94 with a predetermined elastic force, thereby fixing the mask 90. Thus, the mask 90 can be easily fixed by means of the fixing spring 106 even if the height of the mask frame 94 is irregular. In addition, an elastic member, such as a coil spring or heat-resistant rubber, can be employed in order to form the fixing spring 106.

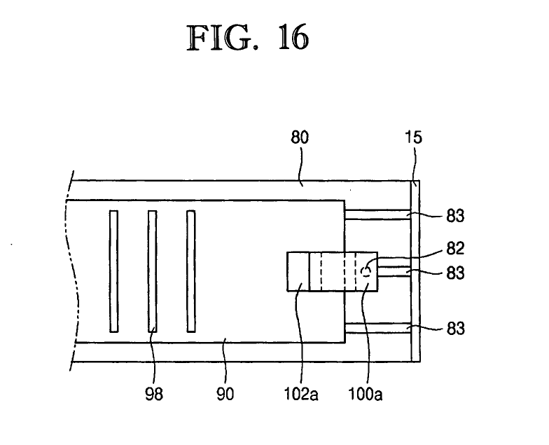

FIG. 16 is a plan view illustrating a substrate fixing section according to still another embodiment of the present invention.

As shown in FIG. 16, the clamp 100a has a size smaller than that of the clamp 100 shown in FIG. 15 so as to fix only a part of the lateral portion of the mask body 92. Other elements of the clamp 100a are identical to those of the clamp 100 shown in FIG. 15, and so they will not be further described below.

Hereinafter, the operation of the substrate fixing section 70 according to one embodiment of the present invention will be described with reference to FIGS. 1, 10b, 11a-11b, 12, 13, 15 and 16.

The substrate fixing section 70 loads the substrate 30 on the upper surface of the chuck 80 installed in the process chamber 10, and loads the mask 90 on the upper surface of the substrate 30. In addition, the substrate fixing section 70 couples the mask frame 94 of the mask 90 to the fixing groove 104 of the clamp 100, and fixes the clamp 100 to the upper portion of the chuck 80. Since it is not necessary to precisely match the height of the mask frame 94 with the depth of the fixing groove 104, if the fixing spring 106 is provided in the fixing groove 104 of the clamp 100, the mask 90 can be easily fixed.

After fixing the substrate 30 and the mask 90 to the upper surface of the chuck 80, an external cooling gas feeding apparatus (not shown) is operated so as to feed cooling gas to the upper surface of the chuck 80 through the central vertical hole 81. Preferably, He gas is used as the cooling gas. The cooling gas fed onto the upper surface of the chuck 80 flows through the lateral portions of the chuck 80 along the upper slots 83 formed at the upper surface of the chuck 80, thereby cooling the substrate 30 and the mask 90.

In the meantime, if the outer vertical holes 82 are formed in the chuck 80 together with the central vertical hole 81, the cooling gas is also introduced onto the upper surface of the chuck through the outer vertical holes 82. Accordingly, a part of the cooling gas introduced onto the upper surface of the chuck 80 through the outer vertical holes 82 may flow through the lateral portions of the chuck 80, but the remaining part of the cooling gas may flow toward the center portion of the chuck 80 while making contact with the cooling gas fed through the central vertical hole 81, thereby guiding the cooling gas toward the upper portion of the clamp 100 through the mask frame 94 and the fixing groove 104. Accordingly, it is possible to effectively cool the mask frame 94 and the clamp 100.

As described above, the ICP-CVD apparatus according to the present invention can uniformly form plasma in a rectangular shape so that the thin film can be evenly formed over the entire area of the rectangular substrate.

In addition, the RF antenna according to the present invention can generate large-size plasma so that thin films can be effectively formed at the same time on plural substrates having various sizes.

In addition, the gas spray nozzle section according to the present invention can individually spray various reaction gases used for the CVD process so that the reaction gases can be prevented from reacting with each other in the pipes or nozzles, thereby preventing the pipes and nozzles from clogging.

Furthermore, the substrate fixing section according to the present invention can maintain the substrate and the mask at a low temperature by using separate cooling gas when forming the thin film on the substrate, so that damage to the organic film formed on the substrate can be prevented while minimizing deformation of the mask.

In addition, the substrate fixing section according to the present invention allows the cooling gas to make contact directly with the mask frame and the clamp by supplying the cooling gas onto the upper surface of the chuck from an external portion of the upper surface of the chuck, and the surface of the clamp is aluminum-anodized, thereby improving the cooling effect of the mask.

Moreover, since the fixing spring is installed in the clamp, the mask can be easily fixed without precisely matching the mask frame with the fixing groove of the clamp when coupling the mask frame with the fixing groove of the clamp.

Although a preferred embodiment of the present invention has been described for illustrative purposes, those skilled in the art will appreciate that various modifications, additions and substitutions are possible without departing from the scope and spirit of the invention as disclosed in the accompanying claims.

1. An inductively coupled plasma chemical vapor deposition apparatus, comprising:
a process chamber having a sealed cavity therein and including an upper wall made from a dielectric material;
an RF antenna installed at an outer portion of the process chamber adjacent to the upper wall of the process chamber and receiving radio frequency (RF) power from an RF power source;
a gas spray nozzle section, including a central gas spray nozzle part installed at a center portion of the upper wall and positioned below the RF antenna, and an outer gas spray nozzle part installed at an upper portion of a chamber body of the process chamber; and
a substrate fixing section installed at an inner lower portion of the process chamber for receiving a substrate disposed thereon.

2. The inductively coupled plasma chemical vapor deposition apparatus as claimed in claim 1, wherein the RF antenna has a rectangular shape and includes at least two positive electrode rods having linear shapes and aligned in parallel with each other on a same plane while forming a predetermine interval therebetween, at least one negative electrode rod having a linear shape and aligned on a same plane alternately with said at least two positive electrode rods, a common terminal for electrically connecting a first end of said at least two positive electrode rods to a first end of said at least one negative electrode rod, a positive electrode terminal electrically connected to a second end of said at least two positive electrode rods, and a negative electrode terminal electrically connected to a second end of said at least one negative electrode rod.

3. The inductively coupled plasma chemical vapor deposition apparatus as claimed in claim 2, wherein said at least one negative electrode rod is aligned between said at least two positive electrode rods.

4. The inductively coupled plasma chemical vapor deposition apparatus as claimed in claim 2, wherein said at least two positive electrode rods are aligned between said at least one negative electrode rod.

5. The inductively coupled plasma chemical vapor deposition apparatus as claimed in claim 2, wherein said at least two positive electrode rods and said at least one negative electrode rod are made from an oxygen free copper pipe.

6. The inductively coupled plasma chemical vapor deposition apparatus as claimed in claim 5, wherein the oxygen free copper pipe is coated with one of gold and silver.

7. The inductively coupled plasma chemical vapor deposition apparatus as claimed in claim 5, wherein said at least two positive electrode rods and said at least one negative electrode rod are movably coupled to the common terminal such that a distance between said at least two positive electrode rods and said at least one negative electrode rod is adjustable.

8. The inductively coupled plasma chemical vapor deposition apparatus as claimed in claim 1, wherein the central gas spray nozzle part is installed at a center portion of the gas spray nozzle section and sprays gas in a downward direction thereof, and the outer gas spray nozzle part has a rectangular ring shape, each side of the outer gas spray nozzle part being spaced from the central gas spray nozzle part, and wherein gas is sprayed from an inner portion of the outer gas spray nozzle part in one of a downward direction and a horizontal direction, and wherein the outer gas spray nozzle part sprays the gas such that the gas is distributed around gas sprayed by the central gas spray nozzle part.

9. The inductively coupled plasma chemical vapor deposition apparatus as claimed in claim 8, wherein the central gas spray nozzle part includes a support block having a gas feeding hole passing through the support block and a coupling hole formed at a central lower portion of the support block and communicating with the gas feeding hole, and a central gas spray nozzle having a block shape, the central gas spray nozzle having a central hole formed at a center portion thereof, the central hole passing through the central gas spray nozzle and being coupled to the coupling hole of the support block.

10. The inductively coupled plasma chemical vapor deposition apparatus as claimed in claim 9, wherein the central gas spray nozzle has a circular plate shape and the central hole has one of a circular shape and a rectangular shape.

11. The inductively coupled plasma chemical vapor deposition apparatus as claimed in claim 9, wherein the central gas spray nozzle has a rectangular plate shape and the central hole has one of a circular shape and a rectangular shape.

12. The inductively coupled plasma chemical vapor deposition apparatus as claimed in claim 8, wherein the outer gas spray nozzle part includes a body having a rectangular ring shape, each side of the body being formed with at least three perforated holes.

13. The inductively coupled plasma chemical vapor deposition apparatus as claimed in claim 12, wherein said at least three perforated holes are downwardly inclined from an outer peripheral portion to an inner peripheral portion of the body by a predetermined angle and are directed toward a center of the body, and all of said at least three perforated holes, except for the perforated holes aligned in each center portion of each side of the body, are biased in one of a left direction and a right direction by a predetermined angle.

14. The inductively coupled plasma chemical vapor deposition apparatus as claimed in claim 12, wherein the outer gas spray nozzle part includes at least two bodies having a rectangular ring shape, said at least two bodies being stacked in a longitudinal direction thereof.

15. The inductively coupled plasma chemical vapor deposition apparatus as claimed in claim 8, wherein the outer gas spray nozzle part comprises a body having a rectangular ring shape, the body including an upper body section and a lower body section having a rectangular ring shape and coupled to each other, and wherein a rectangular ring-shaped passage slot communicating with outer portions of one of the upper body section and the lower body section is formed at one of a lower surface of the upper body section and an upper surface of the lower body section, and wherein at least three perforated holes communicating with a passage slot are connected to an inner portion of one of the upper body section and the lower body section.

16. The inductively coupled plasma chemical vapor deposition apparatus as claimed in claim 1, wherein the substrate fixing section includes:
a chuck on which the substrate is installed and having a central vertical hole vertically extending from an upper center portion of the chuck to a lower center portion of the chuck by passing through the chuck, and having upper slots for connecting the central vertical hole to both side portions of the chuck;
a mask installed on the upper surface of the substrate and having a thin film pattern to be formed on the substrate; and
a clamp installed at said both side portions of the chuck so as to fix the mask to an upper portion of the substrate.

17. The inductively coupled plasma chemical vapor deposition apparatus as claimed in claim 16, wherein the upper slots include at least three horizontal upper slots horizontally formed in parallel with each other between said both side portions of the chuck while forming a predetermined interval therebetween, and a vertical upper slot for connecting said at least three horizontal upper slots with each other.

18. The inductively coupled plasma chemical vapor deposition apparatus as claimed in claim 16, wherein the upper slots are formed radially outward from the central vertical hole to said both side portions and to upper and lower portions of the chuck.

19. The inductively coupled plasma chemical vapor deposition apparatus as claimed in claim 16, further comprising outer vertical holes extending from an upper portion of the chuck to a lower portion of the chuck by passing through the chuck while being spaced from said both side portions of the chuck by a predetermined distance so that the outer vertical holes communicate with the upper slots.

20. The inductively coupled plasma chemical vapor deposition apparatus as claimed in claim 16, wherein the mask includes a mask body formed with a thin film pattern and a mask frame provided at side ends of the mask body.

21. The inductively coupled plasma chemical vapor deposition apparatus as claimed in claim 20, wherein the clamp includes a front fixing section protruding from a front end of the clamp toward a center portion of the check and making contact with an upper surface of the mask-so as to fix the mask, and a fixing groove formed at a lower portion of the clamp and coupled with the mask frame so as to support the mask.

22. The inductively coupled plasma chemical vapor deposition apparatus as claimed in claim 21, wherein the clamp further includes a fixing spring which is fixed to an upper portion of the fixing groove and which makes contact with an upper surface of the mask frame so as to support the mask.

23. The inductively coupled plasma chemical vapor deposition apparatus as claimed in claim 22, wherein the fixing spring comprises one of a leaf spring and a coil spring.
